(19) United States
(12) Patent Application Publication
(10) Pub. No.: US 2010/0325554 A1
(43) Pub. Date: Dec. 23, 2010

(54) Photo-Based Network Control Device and Related Method

(76) Inventor: Hsu-Ming Lee, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/769,662

(22) Filed: Apr. 29, 2010

(30) Foreign Application Priority Data
Jun. 22, 2009 (TW) 098120840

(51) Int. Cl. G06F 15/16; G06F 3/041; H04N 5/222; G06F 3/048

(52) U.S. Cl. 715/738; 345/173; 348/207.1; 348/E05.022

(57) ABSTRACT

A photo-based network control device includes a device information database, an image receiving unit, an identification unit, a graphic user interface (GUI) and a network module. The device information database stores operating information of a target device. The image receiving unit obtains a photo image of surroundings including an image of the target device. The identification unit identifies the target device on the photo image to generate an identification result. The GUI displays the photo image and the operating information based on the identification result, and receives a control signal associated with the operating information. The network module transmits an indication signal to the target device according to a network protocol and the control signal.

### BACKGROUND OF THE INVENTION

1. Field of the Invention

The present invention relates to a remote control device for a network system and related method, and more particularly, to a device of performing remote control through a photo-based interface and related method for a network system.

2. Description of the Prior Art

With development and popularity of the network technology, the information appliance (IA) concept has grown. Therefore, it opens a market for the digital home. The concept of the digital home is built on a home network that links up each of independent appliances together, and establishes a common communications protocol. It allows family members to use any device in hand to control electric appliances, audiovisual equipments, and consumer electronic products, to achieve digital content sharing.

The text is in charge of interfaces for appliance remote control. As a result, in such remote control system, a user has to memorize the manufacturers and models of the appliances for selecting a correct object to control. Once there are plenty of appliances or multiple of the same model of the appliances in the same area, for example, two televisions or two digital fans on the same floor, in this situation, it takes more time for the user to memorize text content of the manufacturers and models to avoid selecting a wrong object.

Please refer to FIG. 1, which is a schematic diagram of a remote control interface 12 in home network according to the prior art. The remote control interface 12 lists several controllable appliance models. When the user intends to control one of those appliances, the user must accurately associate appearance of the appliance with the text content of the appliance model to select a correct model. However, accurately committing all models to memory to avoid the incorrect selection causes inconvenience for appliance selecting operation of the user.

### SUMMARY OF THE INVENTION

It is therefore an objective of the present invention to provide a device of performing remote control through a photo-based interface and related method to allow a user to instinctively select a device of interest by vision, instead of memorizing models, titles, or text traits of all controllable devices.

The present invention discloses a photo-based network control device. The photo-based network control device includes a device information database, a image receiving unit, a identification unit, a graphic user interface, and a network module. The device information database is used for storing operation information of a target device. The image receiving unit is used for obtaining a photo image comprising an image of the target device. The identification unit is used for identifying the target device on the photo image to generate an identification result. The graphic user interface includes a display unit and a signal processing unit. The display unit is used for displaying the photo image and displaying the operation information according to the identification result. The signal processing unit is used for receiving a control signal associated with the operating information. The network module is coupled to the target device via a network protocol, and used for transmitting an indication signal to the target device according to the network protocol and the control signal.

The present invention further discloses a photo-based network control method. The photo-based network control method includes steps of obtaining operation information of a target device, obtaining a photo image comprising an image of the target device, identifying the target device on the photo image to generate an identification result, displaying the photo image, displaying the operation information according to the identification result, receiving a control signal associated with the operating information and transmitting an indication signal to the target device according to a network protocol and the control signal.

The present invention further discloses a photo-based network control device. The photo-based network control device includes an image receiving unit, a graphic user interface and a network module. The image receiving unit is used for obtaining a photo image comprising an image of the target device. The graphic user interface includes a display unit and a signal processing unit. The display unit is used for displaying the photo image and operation information according to an identification result. The signal processing unit is used for receiving a control signal associated with the operating information. The network module is coupled to the target device and a control point device via a network protocol. The network module includes a first transmission unit, a first reception unit and a second transmission unit. The first transmission unit is used for transmitting the photo image to the control point device. The first reception unit is used for receiving the identification result associated with the photo image from the control point device and the operation information. The second transmission unit is used for transmitting an indication signal to the target device according to the network protocol and the control signal.

The present invention further discloses a photo-based network control method. The photo-based network control method includes steps of being coupled to a target device and a control point device via a network protocol, obtaining a photo image comprising an image of the target device, transmitting the photo image to the control point device, receiving an identification result associated with the photo image from the control point device and an operation information from the target device, displaying the photo image, displaying the operation information according to the identification result, receiving a control signal associated with the operation information and transmitting an indication signal to the target signal according to the network protocol and the control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a remote control interface in home network in the prior art.

FIG. 2 is a schematic diagram of a network system according to an embodiment of the present invention.

FIG. 3 is an exemplary illustration of an identified photo image according an embodiment of the present invention.

FIG. 4 is a schematic diagram of a photo-based network control device according to an embodiment of the present invention.

FIG. 5 is a flow chart of a photo-based network control process according to an embodiment of the present invention.

FIG. 6 is a schematic diagram of a photo-based network control device according to an embodiment of the present invention.

FIG. 7 is a schematic diagram of an interface for a photo according to an embodiment of the present invention.

FIG. 8 is a flow chart of a photo-based network control process according to an embodiment of the present invention.

FIG. 9 is a schematic diagram of a photo-based network control device according to an embodiment of the present invention.

FIG. 10 is a flow chart of a photo-based network control process according to an embodiment of the present invention.

### DETAILED DESCRIPTION

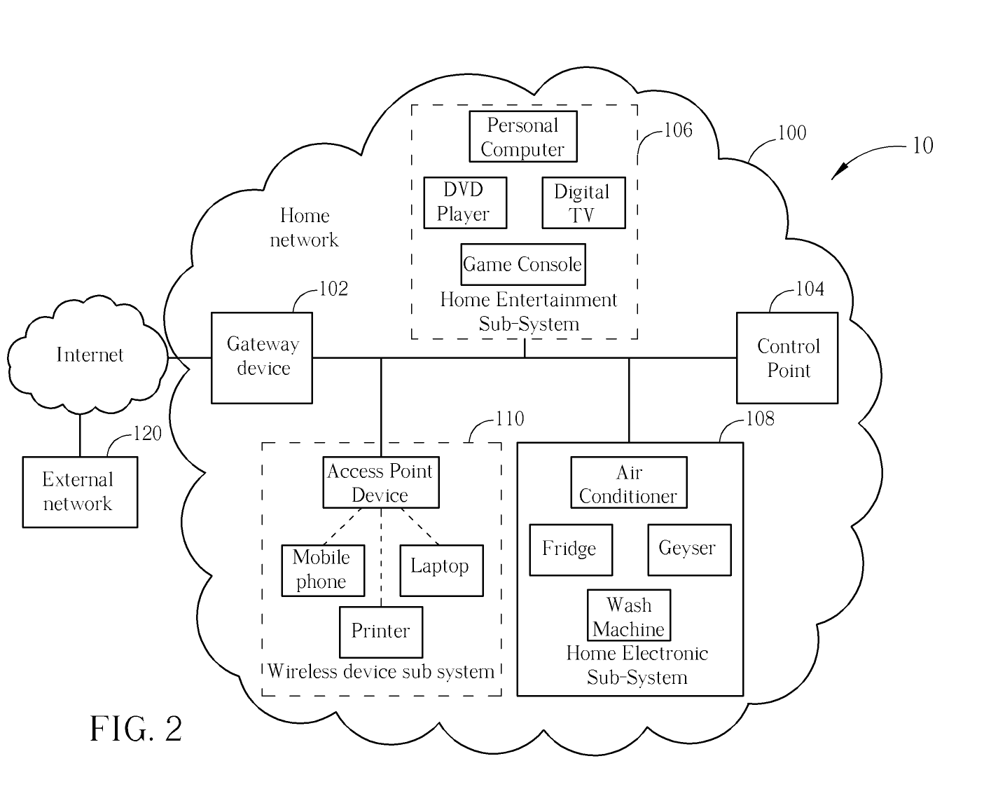

Please refer to FIG. 2, which is a schematic diagram of a network system 10 according to an embodiment of the present invention. The network system 10 includes a home network 100, which employs a gateway device 102 to connect with an external network 120 via a network protocol. In addition, the home network 100 can be built on digital life network alliance (DLNA), energy conservation and homecare network and other network technologies. The home network 100 includes a control point 104, a home entertainment sub-system 106, a home electronic sub-system 108, and a wireless device sub-system 110. The home entertainment sub-system 106 could include audiovisual equipments such as a personal computer, a digital television, a DVD player, a TV game console, home theater devices, and so on. The home entertainment sub-system 106 is connected to the control point 104 through a local area network (LAN) protocol (e.g. Ethernet) to perform game/audiovisual playing and audiovisual data converting. The home electronic sub-system 108 could include electronic appliances such as an air conditioner, a fridge, a geyser, a wash machine, and a microwave oven. Through a power line network, the control point 104 inquires and controls the appliances of the home electronic sub-system 108. The wireless device sub-system 110 includes an access point device not only connecting with the control point 104 through the LAN, but also connecting with wireless devices such as, a camera, a mobile phone, a printer, and a laptop, through the wireless local area network (WLAN) protocol. Any sub-system device of the home entertainment sub-system 106, the home electronic sub-system 108 or the wireless device sub-system 110, for example a digital television or a wash machine, broadcasts its relative information for being discovered on the home network 100. The control point 104 can discover the sub-system devices and retrieve related operation information, such as hardware/software information, state information and service information. The information sharing and service obtaining of the home network mentioned above are supposed to be well known by those skilled in the art, and not elaborated in herein.

Please note that in the network system 10, the control point 104 and the gateway device 102 are independent, but those skilled in the art know that the control point 104 can be embedded in the gateway device 102 so that the gateway device 102 functions as both the gateway device and the home network sever.

In the embodiment of the present invention, a user uses image capture device, such as a digital camera, a mobile phone built-in camera or a webcam, to photograph home environment for obtaining photo images of the home environment including images of the sub-system devices. When the control point 104 obtains those photo images of the home environment, the control point 104 identifies the connected sub-system devices on the photo images automatically or by user's selection and obtains operation information of the sub-system devices which succeed in identifying. After that, when the user performs the remote control by the photo images, the control point 104 displays the operation information associated with target sub-system devices on the photo images, such as device titles, on-off states, service lists and so on. The user first selects the corresponding photo, followed by clicking an image of the target sub-system devices to execute service items of interest, such as function disabling, parameter adjustment, file transmission. Therefore, the user can instinctively select the target sub-system device to control by vision rather than memorize the title and the model of each sub-system device hard.

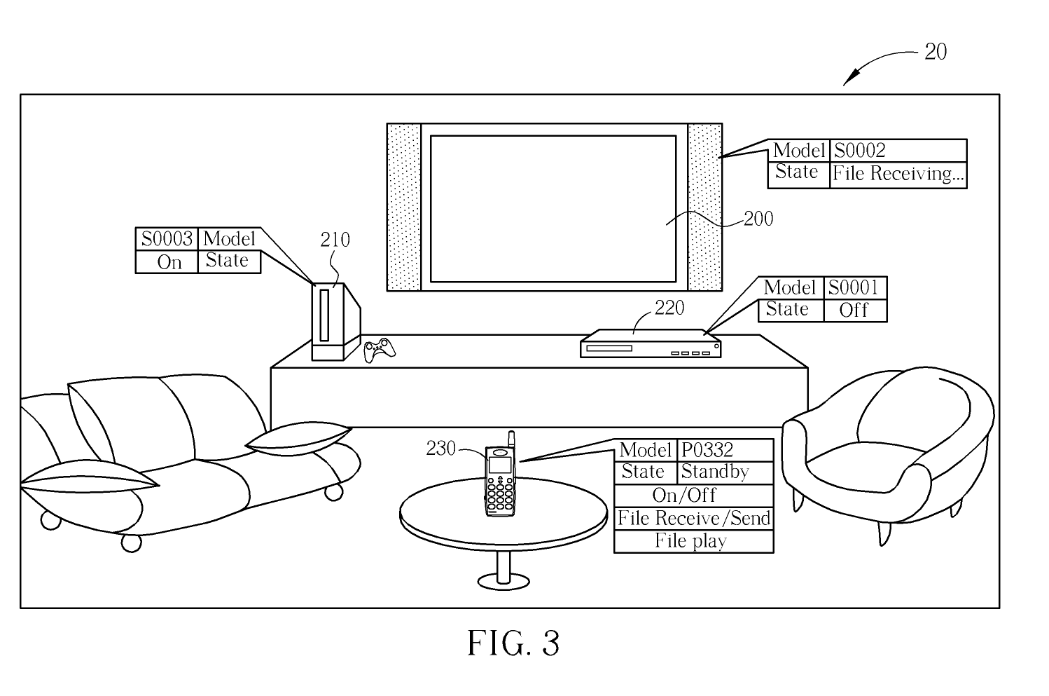

Please refer to FIG. 3, which is an exemplary illustration of an identified photo image 20 according an embodiment of the present invention. The photo image 20 is set as a desktop background on which images of a digital television 200, a game console 210, a set top box 220 and a mobile phone device 230 are successfully identified. Thus, the related device and state information, such as model numbers and on-off states, are shown by the side of the images. In addition, a function list of the mobile phone device 230 are also shown on the photo image 20, which is obtained by converting the service information, including items of “On/Off”, “File Receive/Send”, and “File play”.

Except for controlling the sub-system devices via the control point, the user can use a sub-system device such as, a mobile phone or a laptop, to control other sub-system devices. For example, if the user intends to control a personal computer of the home entertainment sub-system 106 to transmit an image file to the digital television by the mobile phone of the wireless device sub-system 110. First of all, the user uses the mobile phone to photograph the environment surrounding the personal computer and the digital television. Subsequently, the mobile phone device uploads photo images of the surroundings to the control point 104 through wireless network, and the control point 104 performs identification of the personal computer and the digital television. If the identification succeeds, the control point 104 returns an identification result as well as state and service information of the personal computer and digital television. According to the identification result, the mobile phone device is aware that the photo images include the images of the personal computer and the digital television and accordingly setups the relative positions of the two device images on the photo images. Besides, the mobile phone device displays the photo images on which the related state information and the service list are also shown, allowing the user to click on the image of the personal computer and select a “File Send” function, a source image file for transfer, and destination that represents the digital television. Finally, the user clicks on the image of the digital television and selects “File Accept” function to complete the image file transfer.

Please note that, “sub-system device to sub-system device” control is not limited within the home network 100. Generally speaking, the user may go out and thus the portable sub-system device could be carried out of the home network 100 and enter the external network 120. In this situation, a sub-system device of the external network 120 can control the sub-system devices of the home network 100 by a photo-based method through the network interactions. For example, if the mobile phone with an unidentified photo image enters the external network 120, the mobile device can upload the photo to the control point 104 through the Internet for identification of sub-system devices. The control point 104 returns the identification result and related operation information associated with successfully-identified sub-system devices.

The description below is classified into two sections for elaborating on “control point to sub-system device” control and “sub-system device to sub-system device” control.

### 1. Control Point:

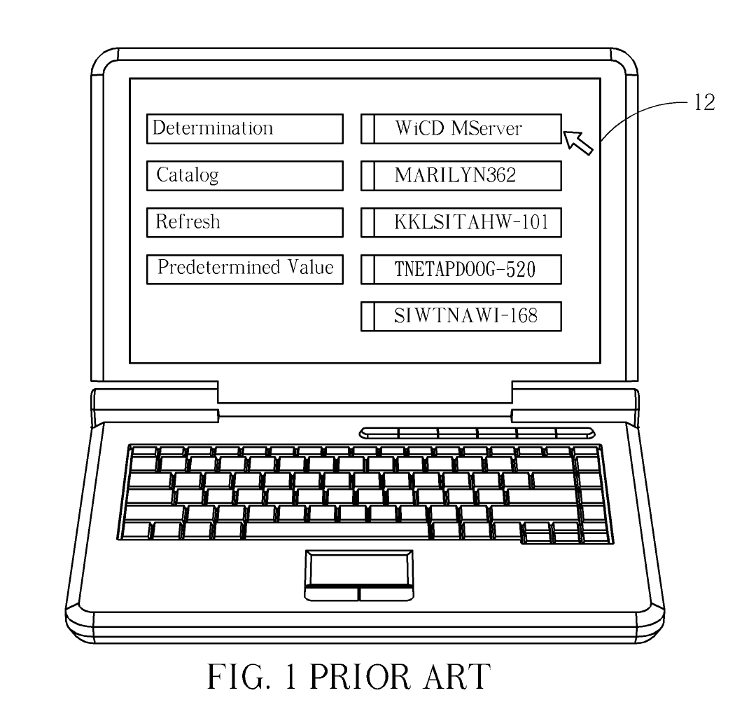

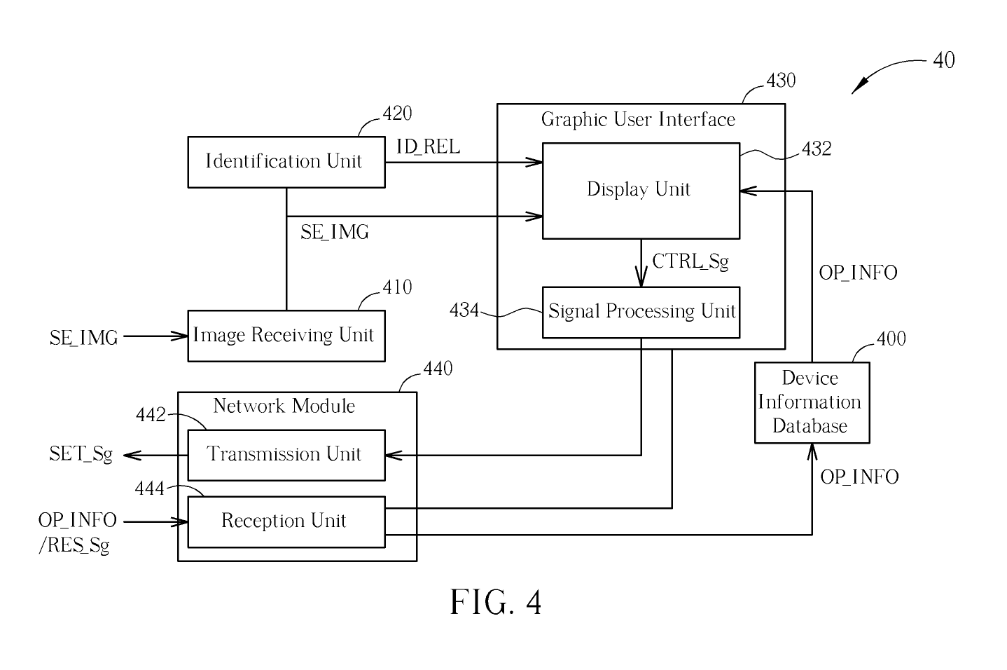

Please refer to FIG. 4, which is a schematic diagram of a photo-based network control device 40 according to an embodiment of the present invention. The photo-based network control device 40 could be utilized in the control point 104 to control a sub-system device via a photo-based control method through the home network protocol. The photo-based network control device 40 includes a device information database 400, an image receiving unit 410, an identification unit 420, and a graphic user interface (GUI) 430, and a network module 440. The GUI includes a display unit 432 and a signal processing unit 434. The network module includes a transmission unit 442 and a reception unit 444. When the control point 104 connects to the home network via the network module 440 and discovers the sub-system device, the reception unit 444 receives operation information OP_INFO broadcasted by the sub-system device and stores the operation information OP_INFO in the device information database 400, such as a hard disk. The image receiving unit 410 could be a wired/wireless communication interface device and can obtain a photo image SE_IMG of the surroundings of the sub-system device in various ways, such as by using a wireless universal serial bus (USB), with interfaces specified by institute of electrical and electronics engineers (IEEE) 1394, or by an email or a text message. The photo image SE_IMG includes an image of the sub-system device. Alternatively, if the photo-based network control device further includes an image capture device (not shown in FIG. 1), the photo SE_IMG is directly transmitted to the image receiving unit 410 after being captured by the image capture device. The identification unit 420 is used for identifying sub-system devices on the photo image SE_IMG to generate an identification result ID_REL. The GUI 430 utilizes the display unit 432 to display all kinds of operation icons and photo images to the user. In addition, according to the identification result ID_REL, the display unit 432 displays the operation information OP_INFO on the image of the sub-system devices or a nearby area. In other words, with the identification result ID_REL, the operation information OP_INFO can be displayed at appropriate positions on the photo image SE_IMG, thereby helping the user to clearly know that the operation information OP_INFO corresponds to the sub-system device, as shown in FIG. 3. Namely, the display unit 432 can convert and capture the operation information OP_INFO to provide a service list or menu to help the user to select a control item for a sub-system device of interest. In addition, preferably, the display unit 432 displays the operation information OP_INFO in the photo image SE_IMG after the identification result ID_REL indicates that identification of the sub-system device succeeds. When the user selects the service list or menu provided by the display unit 432, the signal processing unit 434 is utilized for receiving a control signal CTRL_Sg associated with the operation information OP_INFO. In other words, the signal processing unit 434 receives control signals with respect to the control item selected by the user. Besides, if the photo-based network control device 40 further includes a touch panel (not shown in FIG. 4), the control signal CTRL_Sg is obtained by converting a touch signal on the touch panel. The transmission unit 442 of the network module 440 transmits an indication signal SET_Sg for the control of the sub-system device according to the control signal CTRL_Sg and home network protocol. As a result, the sub-system device receives the indication signal SET_Sg through the network and accordingly executes operation associated with the control item selected by the user. When the operation associated with the control item has been executed, the sub-system device sends a response signal RES_Sg to the reception unit 444 through the home network.

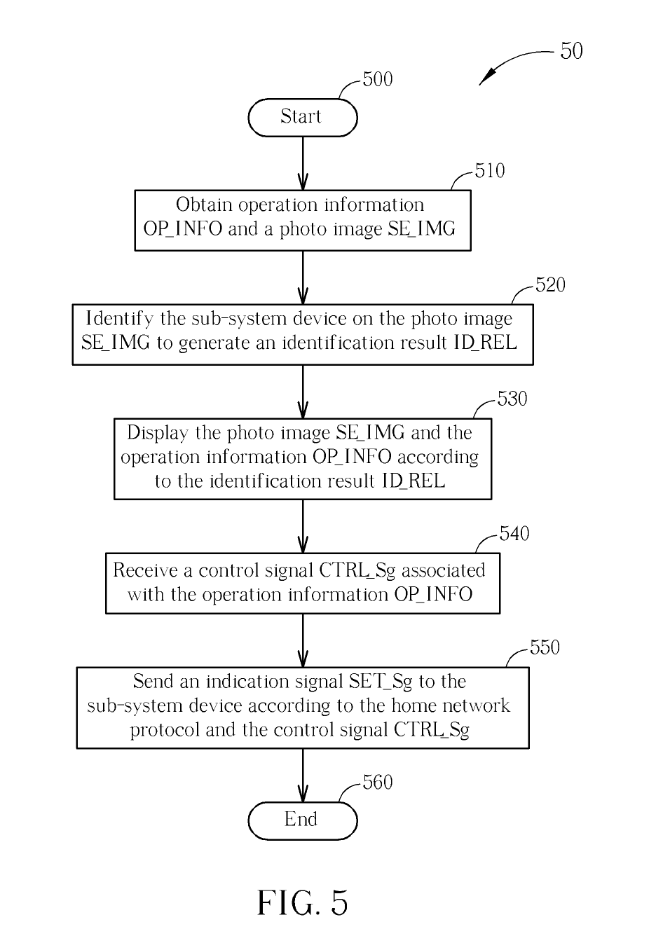

Please refer to FIG. 5, which is a flow chart of a photo-based network control process 50 according to an embodiment of the present invention. The photo-based network control process 50 includes the following steps:

Step 500: Start.

Step 510: Obtain operation information OP_INFO and a photo image SE_IMG.

Step 520: Identify the sub-system device on the photo image SE_IMG to generate an identification result ID_REL.

Step 530: Display the photo image SE_IMG and the operation information OP_INFO according to the identification result ID_REL.

Step 540: Receive a control signal CTRL_Sg associated with the operation information OP_INFO.

Step 550: Send an indication signal SET_Sg to the sub-system device according to the home network protocol and the control signal CTRL_Sg.

Step 560: End.

The photo-based network control process 50 can be utilized for realizing the photo-based network control device 40. Therefore, the detailed operations can be known by referring to description of FIG. 4 and thus not elaborated on herein.

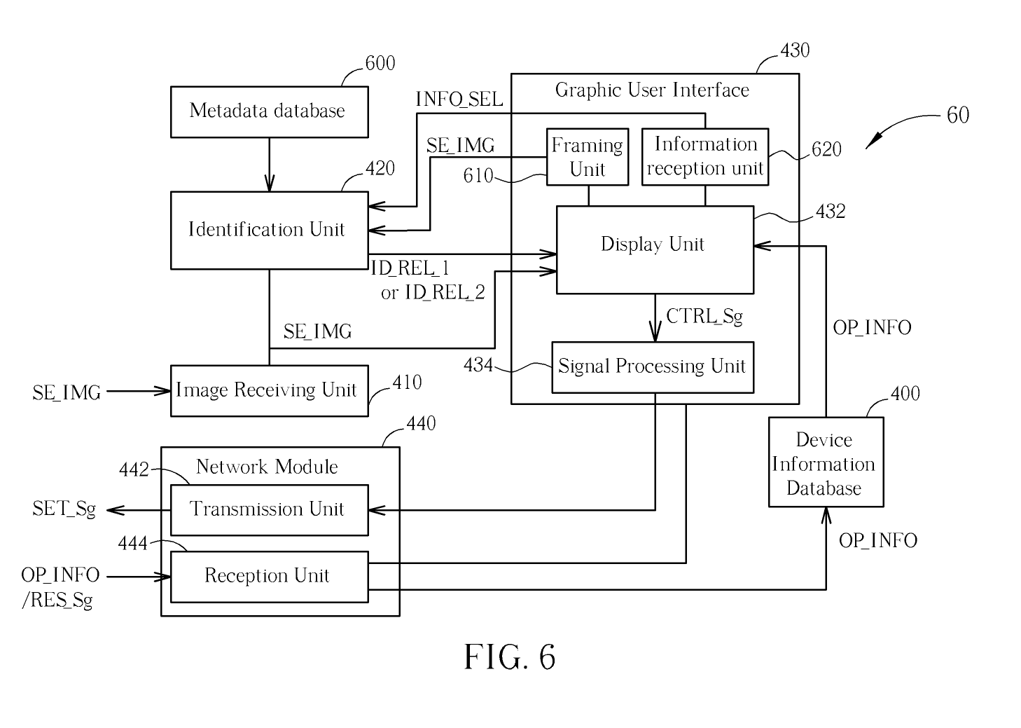

In order to further state the aforementioned photo image identifying, please refer to FIG. 6, which is a schematic diagram of a photo-based network control device 60 according to an embodiment of the present invention. Most of the components of the photo-based network control device 60 are identical to the components of the photo-based network control device 40, except for a metadata data base 600, a framing unit 610, and an information reception unit 620. In the photo-based network control device 60, there are two types of identification mode for identifying the photo SE_IMG. One is an automatic identification mode, in which the metadata database 600 offers a reference photo and related manufacturing information of the sub-system device, provided by the manufacturer. The identification unit 420 in FIG. 6 identifies the image of the sub-system device on the photo image SE_IMG to generate an identification result ID_REL1, using an image comparing technique. Therefore, the automatic identification mode is that the metadata database 600 works with the identification unit 420 to achieve the automatic identification function of the photo-based network control device 60. The other mode is a user-selected identification mode in which the framing unit 610 obtains a framed image IMG_SEL by framing a user-selected image on the photo SE_IMG. The information reception unit 620 receives user-selected operation information INFO_SEL provided by the user. The user-selected operation information INFO_SEL can includes the model and manufacturer information. In this situation, the identification unit 420 in FIG. 6 identifies the sub-system on the photo image SE_IMG according to the user-selected operation information INFO_SEL and the framed image IMG_SEL to generate an identification result ID_REL2. Thus, even if the photo-based network control device 60 cannot automatically identify the sub-system device, the user still can manually establish the sub-system of interest on the photo image SE_IMG by the user-selected identification mode. When the automatic identification mode coexists with the user-selected identification mode, the GUI displays the photo image SE_IMG and the related operation information according to the identification results ID_REL1 or ID_REL2.

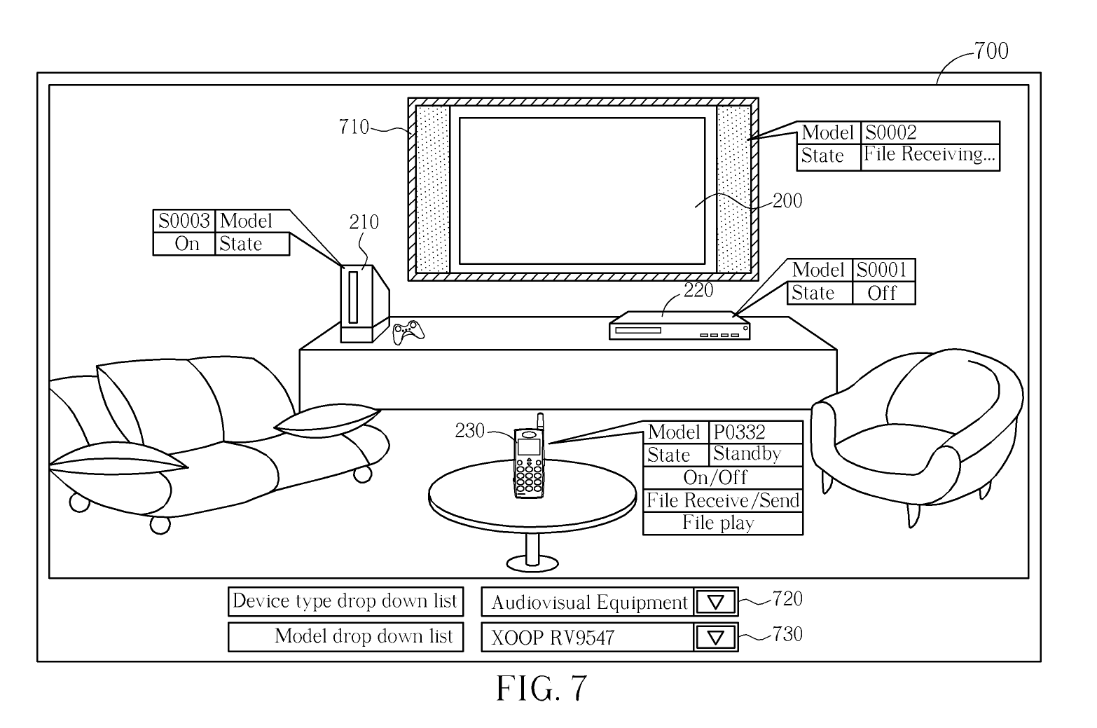

Please refer to FIG. 7, which is a schematic diagram of an interface 70 for a photo image identifying according to an embodiment of the present invention. The interface 70 is utilized for realizing the user-selected identification mode and includes a photo image 700, a frame 710, a device type drop down list 720, and a model drop down list 730. When the digital television on the photo 700 is the user's target device, the user moves the frame 710 onto the digital television image on the photo image 700 and then selects an item “audiovisual equipment” from the device type drop down list 720 and a number “XOOP RV9547” from the model drop down list 730. The image framed by the frame 710 is exactly the farmed image IMG_SEL in FIG. 5. The data selected from the device type drop down list 720 and the model drop down list 730 is considered the user-selected operation information INFO_SEL. Thus, following the previous setups, the device information and service list of the digital television will display on/nearby the digital television image of the photo image 700 for the user.

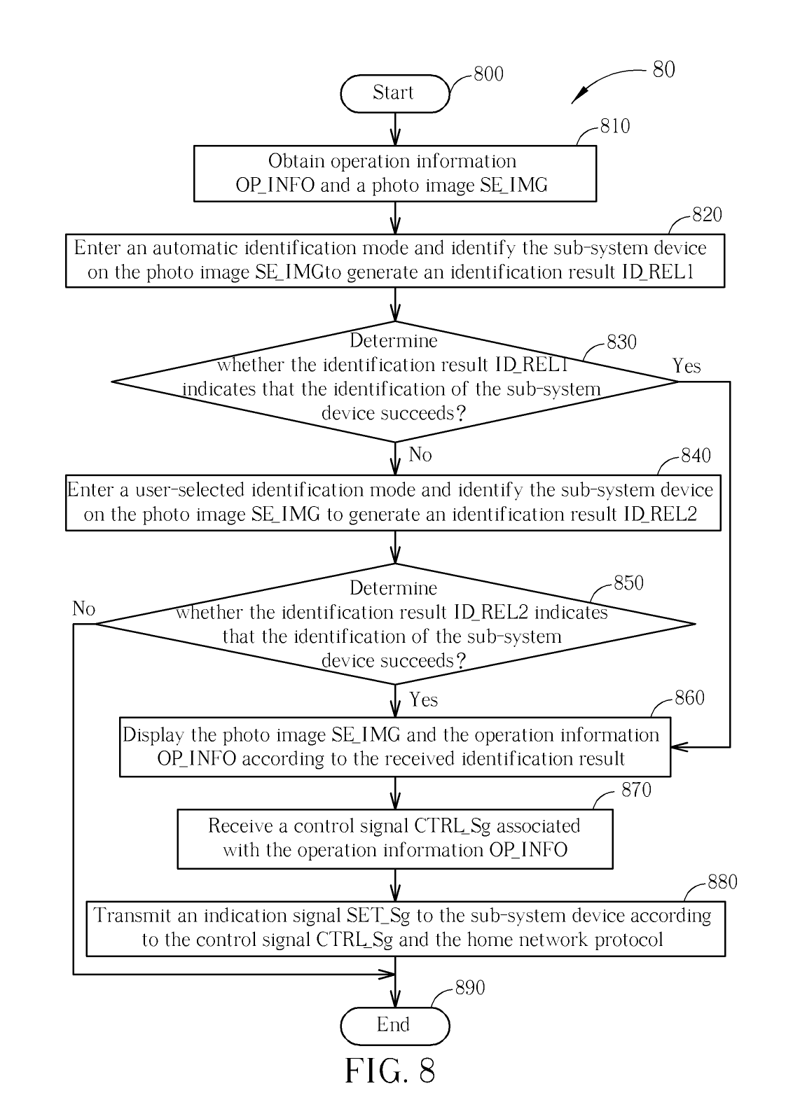

Please refer to FIG. 8, which is a flow chart of a photo-based network control process 80 according to an embodiment of the present invention. The photo-based network control process 80 can realize the automatic identification mode and the user selected identification mode for the photo-based network control device 60. The photo-based network control process 80 includes the following steps:

Step 800: Start.

Step 810: Obtain operation information OP_INFO and a photo image SE_IMG.

Step 820: Enter an automatic identification mode and identify the sub-system device on the photo image SE_IMG to generate an identification result ID_REL1.

Step 830: Determine whether the identification result ID_REL1 indicates that the identification of the sub-system device succeeds? If yes, then go to Step 860; otherwise go to Step 840.

Step 840: Enter a user-selected identification mode and identify the sub-system device on the photo image SE_IMG to generate an identification result ID_REL2.

Step 850: Determine whether the identification result ID_REL2 indicates that the identification of the sub-system device succeeds? If yes, then go to Step 860; otherwise go to Step 890.

Step 860: Display the photo image SE_IMG and the operation information OP_INFO according to the received identification result.

Step 870: Receive a control signal CTRL_Sg associated with the operation information OP_INFO.

Step 880: Transmit an indication signal SET_Sg to the sub-system device according to the control signal CTRL_Sg and the home network protocol.

Step 890: End.

In the photo-based network control process 80, the automatic identification mode has higher priority than the user-selected identification mode. The photo-based network control process 80 can be utilized for realizing the photo-based network control device 60. The detailed operations can be known by referring to the FIG. 6 and thus not elaborated on herein. In addition, if the automatic identification mode and the user-selected identification mode both fail in identification (the identification results ID_REL1 and ID_REL2 both indicate identification failure), the control point can provide the interface which has been used in the prior art, for the user.

### 2. Sub-System Device:

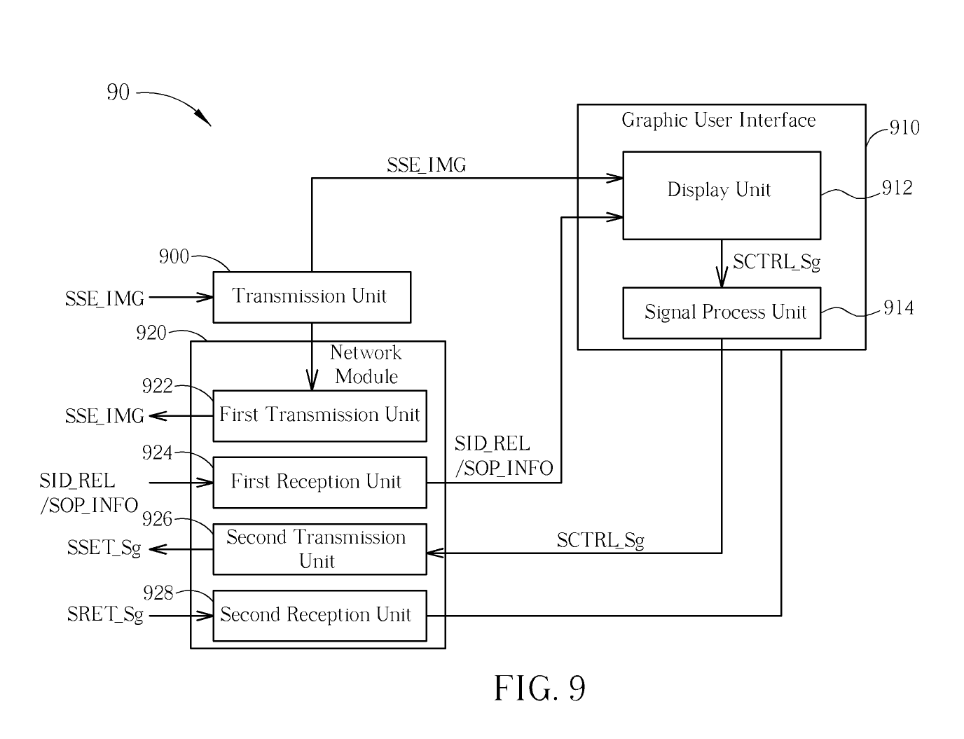

Please refer to FIG. 9, which is a schematic diagram of a photo-based network control device 90 according to an embodiment of the present invention. The photo-based network control device 90 can be applied to the sub-system device with network control function shown in FIG. 1 (e.g. a mobile phone or a laptop), and utilized for controlling another sub-system device by a photo-based control method through the home network protocol. The photo-based control device 90 includes an image receiving unit 900, a GUI 910, a network module 920. The GUI 910 includes a display unit 912 and a signal processing unit 914. The network module 920 includes a first transmission unit 922, a first reception unit 924, a second transmission unit 926, and a second reception unit 928. The image receiving unit 900 is utilized for receiving a photo image SSE_IMG of the surroundings which includes an image of a target device. The network module 920 is coupled to the target device and a control point device (e.g. the control point 104) through the home network protocol. The first transmission unit 922 sends the photo image SSE_IMG to the control point device. The control point device identifies the target device on the photo image SSE_IMG to generate an identification result SID_REL and sends the identification result SID_REL and operation information SOP_INFO of the target device to the first reception unit 924. The display unit 912 displays the photo image SSE_IMG and the operation information SOP_INFO on the photo image SSE_IMG according to the identification result SSE_IMG. The display result can be referred to FIG. 3. When the user selects service items displayed by the display unit 912 or adjusts target device parameters displayed by the display unit 912, the signal processing unit 914 receives a control signal SCTRL_Sg associated with the operation information SOP_INFO. Since the operation of the image receiving unit 900 and GUI 910 is similar to the operation of the above description with respect to the control point. Therefore, the detailed description can be found in the description of FIG. 4. The second transmission unit 926 transmits an indication signal SSET_Sg to the target device according to the home network protocol and the control signal SCTRL_Sg. The target device executes the control item according to the indication signal SSET_Sg. After execution, the target device sends a response signal SRES_Sg to the second reception unit 928 according to an execution result and state.

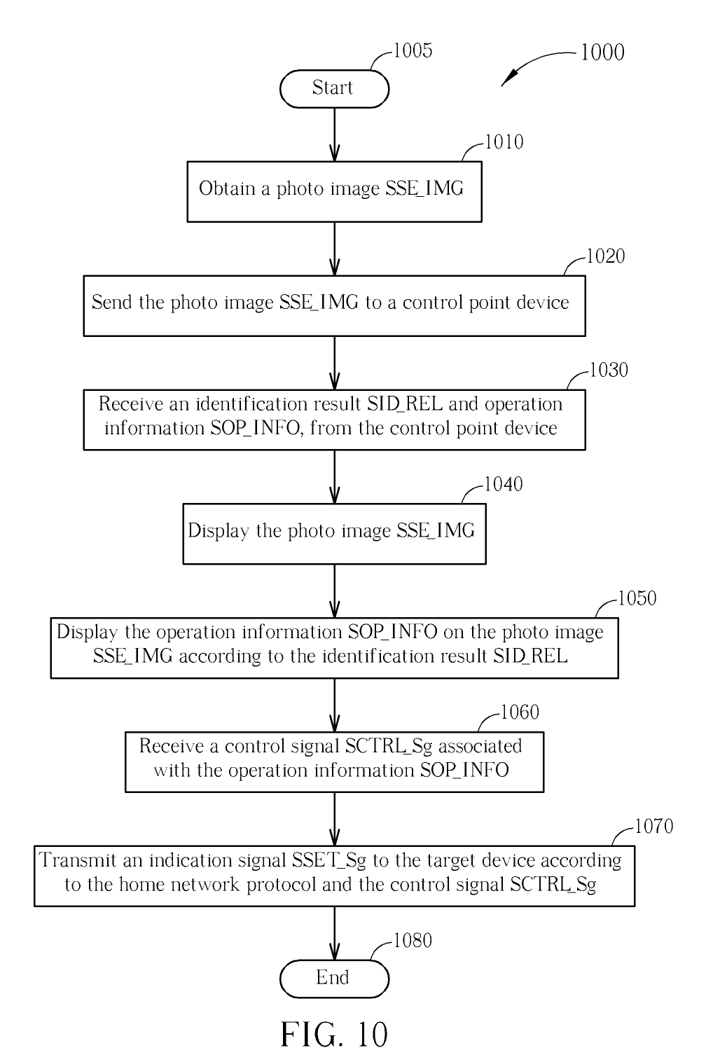

Please refer to FIG. 10, which is a flow chart of a photo-based network control process 1000 according to an embodiment of the present invention. The photo-based network control process 1000 is utilized for realizing the operations of the photo-based network control device 90. It includes the following steps:

Step 1005: Start.

Step 1010: Obtain a photo image SSE_IMG.

Step 1020: Send the photo image SSE_IMG to a control point device.

Step 1030: Receive an identification result SID_REL and operation information SOP_INFO, from the control point device.

Step 1040: Display the photo image SSE_IMG.

Step 1050: Display the operation information SOP_INFO on the photo image SSE_IMG according to the identification result SID_REL.

Step 1060: Receive a control signal SCTRL_Sg associated with the operation information SOP_INFO.

Step 1070: Transmit an indication signal SSET_Sg to the target device according to the home network protocol and the control signal SCTRL_Sg.

Step 1080: End.

In the photo-based network control process 1000, the identification result SID_REL can indicate which part of the photo image SSE_IMG the target device image is on, such that the operation information SOP_INFO is displayed on the image of the target device or nearby area thereof. Further, the user can know a mapping relationship between the operation information SOP_INFO and the target device image. Since the photo-based network control process 1000 can be utilized for realizing the photo network control device 90, the detailed description is not elaborated herein.

Please note that, the aforementioned description of the control point and the sub-system device is addressed for simplicity so only one sub-system is seen as the target device. In normal situation, the photo image usually includes images of multiple target devices. The database of the control point may include information of the multiple sub-systems. Thus, the control point is able identify multiple sub-system devices simultaneously. The concept of the related photo-based network control is similar to the aforementioned description and thus not elaborated on herein.

To sum up, the embodiments of the present invention realizes the network remote control through a photo-based interface, allowing the user to instinctively select the target device by vision. In addition, another advantage is that the user can photograph his/her favorite scene as the photo images.

Those skilled in the art will readily observe that numerous modifications and alterations of the device and method may be made while retaining the teachings of the invention.

What is claimed is:

1. A photo-based network control device comprising:
a device information database for storing operation information of a target device;
an image receiving unit for obtaining a photo image of surroundings, the photo image comprising an image of the target device;
an identification unit for identifying the target device on the photo image to generate an identification result;
a graphic user interface (GUI) comprising:
a display unit for displaying the photo image and displaying the operation information according to the identification result; and
a signal processing unit for receiving a control signal associated with the operating information; and
a network module coupled to the target device via a network protocol, for transmitting an indication signal to the target device according to the network protocol and the control signal.

2. The photo-based network control device of claim 1 further comprising a touch panel for receiving a touch signal corresponding to the control signal.

3. The photo-based network control device of claim 1 further comprising an image capture device for capturing the photo image.

4. The photo-based network control device of claim 1, wherein the GUI further comprises:
a framing unit for framing a user-selected image on the photo image to obtain a framed image; and
an information reception unit for receiving user-selected operation information provided by a user.

5. The photo-based network control device of claim 4, wherein the identification unit identifies the target device on the photo image according to the framed image and the user-selected operation information to generate an identification result.

6. The photo-based network control device of claim 1 further comprising a metadata database for storing a reference photo and related information of the target device.

7. The photo-based network control device of claim 6, wherein the identification unit identifies the target device on the photo image according to the metadata database to generate an identification result.

8. The photo-based network control device of claim 1, wherein the network module further receives a response signal of the target device and the operation information broadcasted by the target device.

9. The photo-based network control device of claim 1, wherein the operation information comprises hardware information, software information, state information, and service information.

10. The photo-based network control device of claim 1, wherein the display unit displays the photo image and the operation information after the identification result indicates that identification of the target device succeeds.

11. A photo-based network control method comprising steps of:
obtaining operation information of a target device;
obtaining a photo image of surroundings, the photo image comprising an image of the target device;
identifying the target device on the photo image to generate an identification result;
displaying the photo image;
displaying the operation information according to the identification result;
receiving a control signal associated with the operating information; and
transmitting an indication signal to the target device according to a network protocol and the control signal.

12. The photo-based network control method of claim 11 further comprising:
framing a user-selected image on the photo image to obtain a framed image; and
receiving a user-selected operation information provided by the user.

13. The photo-based network control method of claim 12, wherein the step of identifying the target device on the photo image to generate an identification result comprises identifying the target device on the photo image according to the user-selected operation information and the framed image to generate the identification result.

14. The photo-based network control method of claim 11 further comprising the step of obtaining a metadata database which stores a reference photo and related information of the target device.

15. The photo-based network control method of claim 14, wherein the step of identifying the target device on the photo image to generate an identification result comprises identifying the target device on the photo image according to the metadata database to generate the identification result.

16. The photo-based network control method of claim 11 further comprising the step of receiving a response signal of the target device and the operation information broadcasted by the target device.

17. The photo-based network control method of claim 11, wherein the operation information comprises hardware information, software information, state information and service information.

18. The photo-based network control method of claim 11, wherein the step of displaying the operation information according to the identification result comprises displaying the operation information after the identification result indicates that identification of the target device succeeds.

19. A photo-based network control device comprising:
an image receiving unit for obtaining a photo image of surroundings, the photo image comprising a photo of the target device;
a graphic user interface (GUI) comprising:
a display unit for displaying the photo image and displaying operation information of the target device according to an identification result; and
a signal processing unit for receiving a control signal associated with the operating information; and
a network module coupled to the target device and a control point device via a network protocol, the network module comprising:
a first transmission unit for transmitting the photo image to the control point device;
a first reception unit for receiving the identification result associated with the photo image and the operation information, from the control point device; and
a second transmission unit for transmitting an indication signal to the target device according to the network protocol and the control signal.

20. The photo-based network control device of claim 19 further comprising a touch panel for receiving a touch signal corresponding to the control signal.

21. The photo-based network control device of claim 19 further comprising an image capture device for capturing the photo image.

22. The photo-based network control device of claim 19, wherein the control point device identifies the target device on the photo image to generate the identification result.

23. The photo-based network control device of claim 19, wherein the network module further comprises a second reception unit for receiving a response signal of the target device.

24. The photo-based network control device of claim 19, wherein the operation information comprises hardware information, software information, state information and service information.

25. The photo-based network control device of claim 19, wherein the display unit displays the operation information after the identification result indicates that identification of the target device succeeds.

26. A photo-based network control method comprising steps of:
utilizing a network protocol to be coupled to a target device and a control point device;
obtaining a photo image of surroundings, the photo image comprising an image of the target device;
transmitting the photo image to the control point device;
receiving an identification result associated with the photo image and operation information of the target device, from the control point device;
displaying the photo image;
displaying the operation information according to the identification result;
receiving a control signal associated with the operation information; and
transmitting an indication signal to the target signal according to the network protocol and the control signal.

27. The photo-based network control method of claim 26, wherein the target device on the photo image is identified by the control point device to generate the identification result.

28. The photo-based network control method of claim 26 further comprising the step of receiving a response signal of the target device.

29. The photo-based network control method of claim 26, wherein the operation information comprises hardware information, software information, state information and service information.

30. The photo-based network control method of claim 26, wherein the step of displaying the operation information according to the identification result comprises displaying the operation information after the identification result indicates that identification of the target device succeeds.
